(19) United States
(12) Patent Application Publication
(10) Pub. No.: US 2003/0226139 A1
(43) Pub. Date: Dec. 4, 2003

(54) System update protocol

(76) Inventor: Sheng Lee, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/156,303

(22) Filed: May 28, 2002

(51) Int. Cl. G06F 9/445; G06F 9/44; H04L 9/00; G06F 11/30

(52) U.S. Cl. 717/176; 717/171; 713/161; 713/191

(57) ABSTRACT

A system update protocol. A software update is packed into a packed file, which packed file includes a unique signature. The packed file is uploaded from a trusted client computer to the network printer. The integrity of the packed file is automatically checked on the network printer by performing a checksum and signature comparison to ensure the packed file is transmitted correctly. The packed file is resent when the packed file is determined to be corrupt. The packed file is unpacked into a predetermined directory structure of unpacked files. The client computer then signals the network printer cause installation of the software update on the network printer.

### BACKGROUND OF THE INVENTION

This invention is related to a communication protocol for updating files on a printer controller.

A printer controller (or printer), which function is to control all printing functions on a related peripheral output device, will sometimes require files to be loaded from external distribution means for the purpose of providing software upgrades, new software installations, and/or batch configurations. Some printers allow these tasks to be done by physically copying the files to the printer controller via a storage distribution device (e.g., CD-ROM, floppy drive, etc.), and then executing corresponding commands for setup and configuration through conventional input devices (e.g., mouse and keyboard) and a video display panel.

This process proves to be impractical and time-consuming when an administrator has to manage many such printers that are remotely located at many different sites (or network nodes) such as buildings or even across the country.

A workstation user may easily apply a patch for a certain component by running the self-extracting and self-installing patch file provided by a vendor. The same patch may also be applied to the printer controller with the same components. However, because the printer lacks input device accommodations (e.g., monitor, keyboard), it is not easy to initiate the install process of such software updates.

What is needed is a client-server networking protocol that would facilitate uploading of the required file(s) to the printer controller, and issuing of any commands necessary for installation.

### SUMMARY OF THE INVENTION

The present invention disclosed and claimed herein, in one aspect thereof, comprises a system update protocol. A software update is packed into a packed file, which packed file includes a unique signature. The packed file is uploaded from a trusted client computer to the network printer. The integrity of the packed file is automatically checked on the network printer by performing a checksum and signature comparison to ensure the packed file is transmitted correctly. The packed file is resent from the client when the packed file is determined to be corrupt. The packed file is unpacked into a predetermined directory structure of unpacked files. The client computer then signals the network printer cause installation of the software update on the network printer.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates a client/server protocol exchange flow diagram of the protocol; and

FIG. 2 illustrates a client/server system block diagram utilizing the disclosed protocol architecture.

### DETAILED DESCRIPTION OF THE INVENTION

The disclosed protocol architecture provides the capability of allowing the print controller to execute the installation commands after correctly receiving the file.

Unlike most popular file transfer protocols, the disclosed system update protocol is not limited to a single underlying transport. It is designed to run on, for example, TCP/IP (Transmission Control Protocol/Internet Protocol—a Microsoft® protocol suite) and IPX/SPX (Internet Packet eXchange/Sequenced Packet eXchange—a Novell® communication protocol). Thus a client user may choose either transport protocol allowing the server program running on the print controller the capability of responding.

The protocol consists of a reduced set of commands. The one or more target files are packed (i.e., compressed into a single large file) into a packed file, and a signature is prepended to the packed file for security reasons. The packed file may be optionally encrypted with a special agreed-upon key for added security.

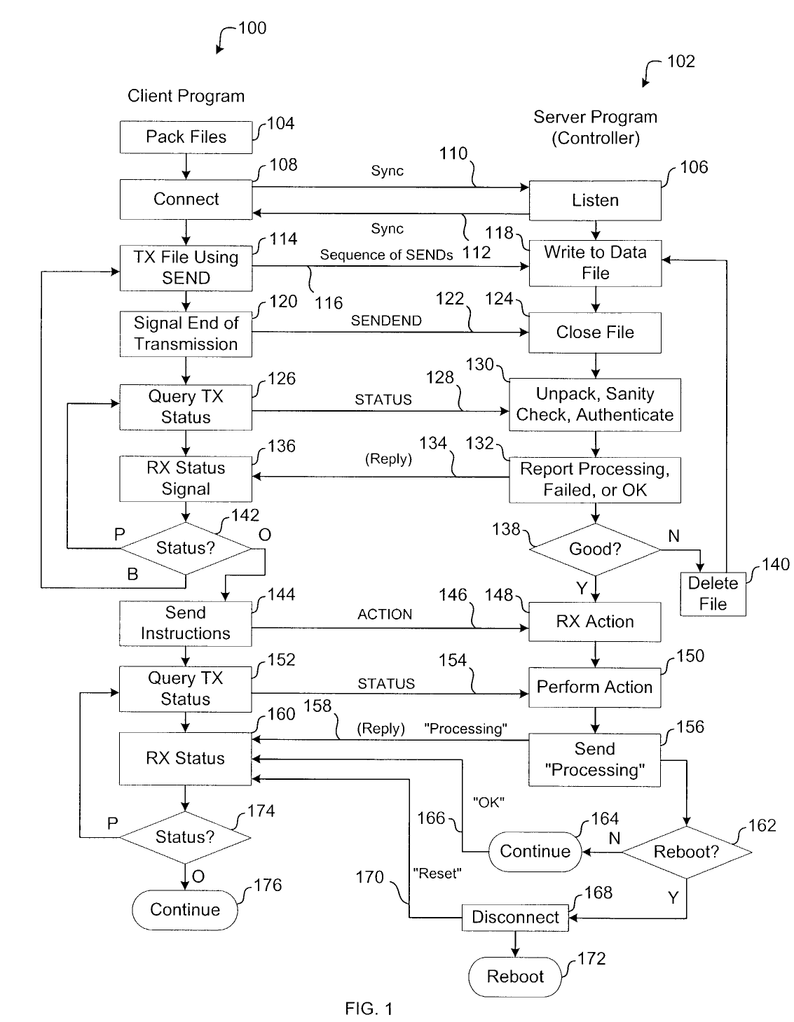

Referring now to FIG. 1, there is illustrated a client/server protocol exchange flow diagram of the protocol. The horizontal lines between a client program flow diagram 100 and server program flow diagram 102 denote the direction and type of content of the network packets exchanged between the client program on a client and server program on the print controller (also denoted as a peripheral output device), while the vertical lines between the blocks of a flow diagram denote the flow of control.

The disclosed protocol consists of the following commands: SEND, to transfer a chunk of the target file; SENDEND, to signal the end of transferring; ACTION, to instruct the server what to do with the file; STATUS, to check the status of the action; and STATUSREPLY, to return the status of the transfer or action.

The server program 102 running on the printer controller is responsible for servicing these commands. The client program 100 running on a workstation (or client) is the driver of a task, i.e., the client controls the processes on the printer controller. Flow begins in a function block 104 where the client program 100 first “packs” all of the appropriate files into a single packed file, which single packed file includes a file header that contains a special signature recognized only by the printer controller (i.e., server program) and trusted client programs. The signature may be encrypted by a variable key (e.g., based upon file size) so that it cannot simply be copied to another file header. The client program 100 also appends a checksum to the end of the packed file. Thus the integrity of the packed file can be ascertained by checking both the unique signature and the checksum.

The server program 102 is currently in a “listen” mode, as indicated in a function block 106, awaiting incoming commands from a client. Flow is then to a function block 108 where the client program 100 performs a connect function by initiating a synchronization (i.e., also denoted as “synch”) operation over a flow line 110 to the function block 106 of the server program 102 in order to establish a reliable connection to the printer controller. The server program 102 responds with synch commands over a flow line 112 to the function block 108. On the server side, two listening sockets will be opened; one for TCP/IP traffic, and another for IPX/SPX traffic.

Flow in the client program 100 is then to a function block 114 where the packed file is transmitted to the printer controller through a sequence of SEND commands. The client program 100 then issues the sequence of SEND commands to the server program 102, as indicated by a signal flow line 116 to a function block 118, to transfer the packed file to the printer controller. Flow in the server program 102 is to the function block 118 where the SEND commands are received, and the received file segments associated with the sequence of the SEND commands are written as a single data file set.

Once the end of the file transfer from the client program 100 is reached, flow in the client program 100 is to a function block 120 where the client program 100 transmits a SENDEND command to the server program 102, as indicated by a signal flow line 122 to a function block 124. Flow in the server program 102 is to the function block 124 where after the last file segment has been received, and the server program 102 closes the data file. When the server program 102 receives SENDEND command, it will have received the entire file.

Flow in the client program 100 is then to a function block 126 where the client program 100 queries the server program 102 for the status of the file transmission by sending the STATUS command, as indicated by a signal flow line 128 to a function block 130. Flow in the server program 102 is to the function block 130 where the data file is unpacked, and a “sanity” check is performed to determine if the file was correctly transmitted, i.e., by authenticating the signature, recalculating the checksum, etc.

While the sanity check is being performed, flow in the server program 102 is to a function block 132 where the printer controller sends back a “processing” Reply signal to the client program 100, as indicated by a signal flow line 134 to a function block 136. In the server program 102, flow continues to a decision block 138 to determine if the received packed file passed the sanity check. If not, flow is out the “N” path to a function block 140, where the packed file is deleted. Flow then loops back to the input of the function block 118 to receive the next retransmission of the packed file.

The server program 102 also signals the client program 100 in the Reply signal of packed file failing the sanity check (i.e., a “corrupted” file). Flow in the client program 100 is to the function block 136 where the status Reply is received. The client program 100 then interrogates the received status Reply signal, as indicated in a decision block 142. If the Reply signal indicates that the server program 102 is in a state of “processing,” flow is out the “P” path back to the input of the function block 126 to continue querying the server program 102. Alternatively, if the Reply signal indicates a “failed” or “bad” sanity check, flow is out the “B” path of decision block 142 back to the input of function block 114 where the client program 100 resends the packed file to the server program 102 in the sequence of SEND commands.

If the sanity check by the server program 102 is “OK”, the Reply signal to the function block 136 of the client program 100 indicates the same, and flow is out the “O” path of the decision block 142 to a function block 144 where the client program 100 sends an ACTION command to the server program 102 instructing the server program 102 to unpack the file set and reconstruct the directory structure associated therewith. (Of course, to facilitate this directory structuring, the printer controller includes a readable storage medium, e.g., hard disk drive, or a sufficient amount of RAM memory to accommodate the unpacked files.) This is indicated by a signal flow line 146 from the function block 144 of the client program 100 to a function block 148 of the server program 102. The ACTION instructions can further include the actions of “controller software update,” “run,” or “configure.”

Flow in the server program 102 is to the function block 148 where the ACTION signal is received and processed. Flow in the server program 102 is to a function block 150 where the received ACTION is performed. The “controller software update” action initiates a predefined installation process in the printer controller to upgrade the existing software. For software installed utilizing the “run” command, the packed file includes at least one executable file. The “run” action simply causes execution of the one or more executable files of the unpacked file set, which is suitable for installing patches for a single module. The “configure” action initiates a special operating system process, e.g., a system command associated with RegEdit, to add/change some system parameters of the printer controller, as specified in the unpacked file set.

The client program 100 may optionally check the execution status of the ACTION in the server program 102. Thus flow is to a function block 152 of the client program 100 where a STATUS signal is transmitted to the server program 102, as indicated by a signal flow line 154 from the function block 152 to the function block 150. If the server program 102 is in the state of executing the ACTION instruction, flow is to a function block 156 where the server program 102 transmits a “processing” Reply signal to the client program 100, as indicated by a Reply signal flow line 158 to a status function block 160 of the client program 100. Note that where the print controller is undergoing an update, the processing time may take longer.

After completion of the ACTION instruction, the server program 102 may need to be rebooted. Thus flow is to a decision block 162 to determine if the server program 102 needs to be rebooted, in accordance with the particular ACTION instruction. If not, flow is out the “N” path of decision block 162 to a Continue terminal 164 of the server, and therefrom signaling an “OK” status across a signal line 166 to the status function block 160 of the client program 100 to indicate that the ACTION has been completed without a reboot. When a reboot is required, flow is out the “Y” path of decision block 162 of the server program 102 to a function block 168 to terminate the connection to the client program 100 during the rebooting process. A “Reset” signal is then transmitted from the server program 102 to the status function block 160 of the client program 100, as indicated by a signal flow line 170 to the status function block 160. Flow is then to a reboot terminal 172 where the server program is rebooted to implement the software updates. Note that the connection between the client and server will not automatically restore after the printer controller restarts.

The client program 100 then takes the appropriate action in response to the signals received into the status function block 160. Thus flow is to a decision block 174 where the client program 100 interrogates the status signals received from the server program 102. If the status is “processing,” flow is out the “P” path back to the input of the function block 152 to continue querying the server program 102. If the status is either “OK” or “Reset,” flow is out the “O” path to a Continue terminal 176 of the client.

The details of Continue terminal 176 of the client are not shown in FIG. 1. The client program 100 may choose to start another transfer on the same connection, i.e., the process associated with a new sequence of SEND commands in the function block 114, or disconnect from the server program 102 (printer controller) and start a new connection to another printer controller.

The details of the Continue terminal 164 on the server side are not shown in FIG. 1. The server program 102 (printer controller) will delete the received file and go back to wait for a new sequence of SEND commands, as associated with function block 118. If the connection is terminated by the client, the controller will return to the listening mode associated with function block 102, to wait for a new connection.

The disclosed protocol works well for a special-purpose printer controller running on top of the operating system having networking support. A general-purpose file transfer protocol (e.g., FTP (File Transfer Protocol)) does not fit the need of issuing specialized commands. The Berkeley socket interface can be used to implement both the client program 100 and server program 102.

Except for the STATUS command, all the other commands do not require an explicit acknowledgment-type of reply from the server. The underlying transport will ensure the correct delivery of the data.

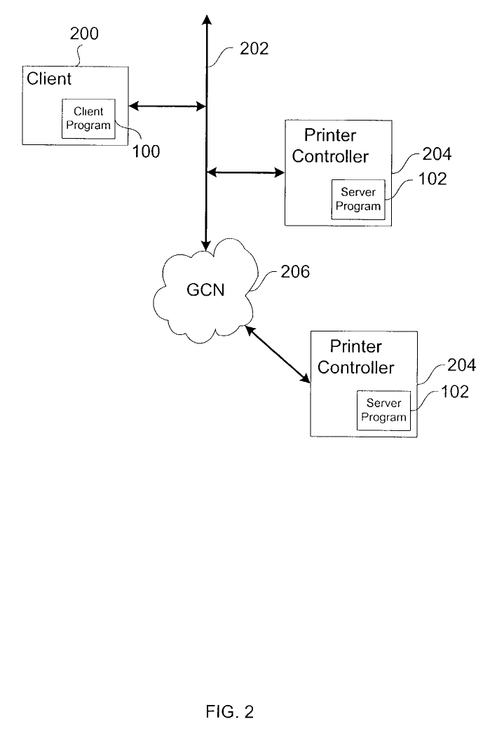

Referring now to FIG. 2, there is illustrated a block diagram of client/server system utilizing the disclosed protocol architecture. A client computer 200 is disposed on a network 202, e.g., a LAN, WAN, etc., in communication with a first network peripheral output device 204, which in this particular embodiment is a printer controller. Note that the first network peripheral output device 204 is not restricted to a printer controller, but can be a variety of network-based equipment suitably configured to execute the disclosed protocol architecture, for example, a multi-function output device (that includes capabilities of faxing, scanning, printing, etc.). The client computer 200 includes the client protocol program 100, and the first peripheral output device 204 includes the server program 102. Both of the client and server protocol programs (100 and 102) can be implemented in firmware (e.g., EEPROM) in either or both of the client computer 200 and the first peripheral output device 204.

As indicated hereinabove, the first peripheral output device 204 opens two listening sockets to accommodate either or both TCP/IP traffic and IPX/SPX traffic communicated across the network 202. Thus if the client computer 200 sends only IPX/SPX traffic on the relatively local network 202, the first peripheral output device 204 can communicate with the client computer 200 to receive the updated software, and execute the disclosed protocol to facilitate the installation of the software and ascertain the status of the updating process on the first peripheral output device 204. It is appreciated that networks can extend great distances utilizing a global communication network (GCN) 206, e.g., the Internet, over which communication is facilitated utilizing the TCP/IP protocol suite. Thus a second peripheral output device 208 disposed on the GCN 206 and executing the disclosed server protocol 102 will also open the two listening sockets to accommodate either or both TCP/IP traffic and IPX/SPX traffic communicated across the GCN 206. Thus the client computer 200 can be used to upload software to the second peripheral output device 208, and monitor the software installation process.

Although the preferred embodiment has been described in detail, it should be understood that various changes, substitutions, and alterations can be made therein without departing from the spirit and scope of the invention as defined by the appended claims.

What is claimed is:

1. A method of updating software on a peripheral output device disposed on a network, comprising the steps of:
transmitting software update data from a client to the peripheral output device; and
installing software update data on the peripheral output device.

2. The method of claim 1, wherein the software update data in the step of transmitting is in the form of a packed file, which packed file includes a unique signature prepended thereto that is recognizable only by the peripheral output device.

3. The method of claim 1, further comprising the step of checking a unique signature and a checksum of the software update data when received at the peripheral output device.

4. The method of claim 1, further comprising the step of structuring the software update data on the peripheral output device into a predetermined directory structure.

5. The method of claim 1, wherein the peripheral output device opens at least one of a TCP/IP socket for receiving TCP/IP traffic and an IPX/SPX socket for receiving IPX/SPX traffic.

6. The method of claim 1, wherein the client sends an instruction to the peripheral output device in the step of installing, which instruction causes the peripheral output device to perform at least one of further steps of running a patch file, configuring a system parameter, and installing a controller software update.

7. The method of claim 1, wherein the peripheral output device communicates a reply signal to the client in response to a query by the client, after the client performs at least one of the steps of transmitting the software update data and installing the software update data.

8. The method of claim 1, wherein peripheral output device communicates a reply signal to the client, which reply signal is associated with at least one of the further steps of,
performing a sanity check of a packed file, which packed file includes the software update data,
authenticating the packed file,
unpacking the packed file of the software update data into a predefined file structure, and
processing an instruction received from the client to install the software update data.

9. The method of claim 1, further comprising the steps of:
checking a unique signature and a checksum of the software update data when received at the peripheral output device,
if the step of checking fails, deleting the software update data at the peripheral output device,
sending a signal from the peripheral output device to the client indicating that the software update data checked in the step of checking, failed, and
in response thereto, retransmitting the software update data from the client to the peripheral output device.

10. A method of updating software on a peripheral output device disposed on a network, comprising the steps of:
on a client, packing software update data into a packed file, which packed file includes a unique signature;
transmitting the packed file from the client to the peripheral output device;
checking the integrity of the packed file at the peripheral output device to ensure the packed file was transmitted correctly;
unpacking the packed file into a predetermined directory structure; and
installing the software update data on the peripheral output device.

11. The method of claim 10, wherein the unique signature of the packed file in the step of packing is prepended thereto and is recognizable only by the peripheral output device.

12. The method of claim 10, wherein the peripheral output device communicates a reply signal to the client in response a query by the client, after the client performs at least one of the steps of transmitting the packed file and installing the software update data on the peripheral output device.

13. The method of claim 12, wherein the reply signal is generated in response to performing at least one of the further steps of,
unpacking the packed file,
performing a sanity check of the packed file,
authenticating the packed file, and
processing an instruction received from the client to install the software update data.

14. A method of updating software on a network printer, comprising the steps of:
packing software update data into a packed file, which packed file includes a unique signature;
transmitting the packed file from a client computer to the network printer;
automatically checking the integrity of the packed file on the network printer to ensure the packed file is transmitted correctly;
replying to the client with a reply signal in response to the client querying the network printer for a status of the step of checking;
unpacking the packed file into a predetermined directory structure of unpacked files;
controlling the network printer from the client computer to execute to cause installation of the software update data on the network printer; and
sending a reply to the client from the network printer in response to the client querying the network printer for a status of the step of controlling.

15. The method of claim 14, wherein the client signals the network printer when an end of the transmission of the packed file has been reached in the step of transmitting.

16. Architecture for updating software on a peripheral output device disposed on a network, comprising:
software update data transmitted from a client to the peripheral output device;
wherein the peripheral output device is controlled by the client to install the software update data.

17. The architecture of claim 16, wherein the software update data is in the form of a packed file, which packed file includes a unique signature prepended thereto that is recognizable only by the peripheral output device.

18. The architecture of claim 16, wherein a unique signature and a checksum of the software update data is checked when received at the peripheral output device.

19. The architecture of claim 16, wherein the software update data is structured into a predetermined directory structure on the peripheral output device.

20. The architecture of claim 16, wherein the peripheral output device opens at least one of a TCP/IP socket for receiving TCP/IP traffic and an IPX/SPX socket for receiving IPX/SPX traffic.

21. The architecture of claim 16, wherein the client sends an instruction to the peripheral output device, which instruction causes the peripheral output device to perform at least one of running a patch file, configuring a system parameter, and installing a controller software update.

22. The architecture of claim 16, wherein the peripheral output device communicates a reply signal to the client in response to a query by the client, after the client performs at least one of transmitting the packed file and controlling the peripheral output device.

23. The architecture of claim 22, wherein the reply signal is associated with at least one of performing a sanity check of the packed file, authenticating the packed file, unpacking a packed file of the software update data, and processing an instruction received from the client cause installation of the software update data.

24. The architecture of claim 16, wherein a unique signature and a checksum of the software update data are both checked when the software update data is received at the peripheral output device, and if the check fails, the software update data is deleted at the peripheral output device, and wherein a signal is sent from the peripheral output device to the client indicating that the software update data failed, in response to which the software update data is retransmitted from the client to the peripheral output device.

25. Architecture for updating software on a peripheral output device disposed on a network, comprising:
software update data that is packed into a packed file, and transmitted from a client to the peripheral output device, which packed file includes a unique signature;
wherein the integrity of the packed file is automatically checked at the peripheral output device to ensure the packed file was transmitted correctly;
wherein the packed file is unpacked into a predetermined directory structure of unpacked files; and
wherein the peripheral output device is controlled by the client to cause installation of the software update data.

26. The architecture of claim 25, wherein the unique signature of the packed file is prepended thereto and is recognizable only by the peripheral output device.

27. The architecture of claim 25, wherein the peripheral output device communicates a reply signal to the client in response to the client performing at least one of transmitting the packed file and controlling the peripheral output device.

28. The architecture of claim 27, wherein the reply signal is generated in response to the peripheral output device performing at least one of the steps of,
unpacking the packed file,
performing a sanity check of the packed file,
authenticating the packed file, and
processing an instruction received from the client to cause installation of the software update data.

29. Architecture for updating software on a peripheral output device disposed on a network, comprising:
software update data that is packed into a packed file, and transmitted over a network from a client to the peripheral output device, which packed file includes a unique signature;
wherein the integrity of the packed file is automatically checked at the peripheral output device to ensure the packed file was transmitted correctly;
wherein a reply signal is sent to the client in response to the client querying the network printer for a status of the integrity check;
wherein the packed file is unpacked into a predetermined directory structure of unpacked files;
wherein the peripheral output device is controlled by the client to cause installation of the software update data; and
wherein a reply is sent to the client from the network printer in response to the client querying the network printer for a status of the network printer being controlled.

30. The architecture of claim 29, wherein the client signals the network printer when an end of the transmission of the packed file has been reached.

31. The architecture of claim 29, wherein the network is a global communication network.
